(19) United States
(12) Patent Application Publication
(10) Pub. No.: US 2011/0086154 A1
(43) Pub. Date: Apr. 14, 2011

(54) FOOD AND BEVERAGE FOAMS

(75) Inventors: John Hawkins, Kinver South Staffordshire (GB); Tim Staniland, Boston Lincolnshire (GB)

(73) Assignee: LIBAERATION LIMITED, Butterwick, Boston (GB)

(21) Appl. No.: 12/672,389

(22) PCT Filed: Aug. 7, 2008
(86) PCT No.: PCT/GB08/02690

§ 371 Date: Feb. 5, 2010

(30) Foreign Application Priority Data
Aug. 7, 2007 (GB) 0715348.9
Aug. 11, 2007 (GB) 0715720.9
Sep. 15, 2007 (GB) 0718041.7
Nov. 7, 2007 (GB) 0721776.3
Dec. 8, 2007 (GB) 0724017.9
Dec. 24, 2007 (GB) 0725208.3
Mar. 4, 2008 (GB) 0803978.6
Mar. 20, 2008 (GB) 0805179.9
Mar. 29, 2008 (GB) 0805707.7
Apr. 12, 2008 (GB) 0806680.5
Apr. 19, 2008 (GB) 0807191.2
May 23, 2008 (GB) 0809394.0

(51) Int. Cl. A23L 1/00; A23L 1/035

(52) U.S. Cl. 426/564; 426/474

(57) ABSTRACT

A foam comprising an aqueous or aqueous ethanolic solution of a surfactant, which is suitable for food use, and which has an HLB greater than 9; is used to form a foam topping on a drink or food, e.g. by spraying from a foam dispenser.

The invention relates to food and beverage foams, which are suitable, inter alia, for use in the preparation of foam topped beverages, such as cappuccino-style coffee, and foam toppings on deserts, cocktails and other comestibles.

Cappuccino is a popular form of coffee with a foamed milk head. It requires relatively bulky and expensive equipment to produce the foam, which normally restricts its preparation to commercial establishments. It is unsuitable for consumers with a milk allergy, or those on vegetarian or low fat diets.

Attempts have been made to produce spray-on, aerosol milk-foams, which would not need special equipment and would be suitable for domestic use, but difficulties have been encountered obtaining a product which is acceptable to consumers. Dairy products generally have a limited shelf life and require refrigeration. Non-dairy products are not currently available. There is also a potential demand for flavoured, and in particular alcoholic, foam e.g. as a topping for a variety of foods and beverages, such as cocktails and desserts and as a confection in its own right.

A particular problem arises with products such as energy drinks, which are frequently sipped intermittently by people engaged in demanding physical or mental activity, e.g. by motorists to avoid drowsiness while driving. Drinking liquid in this way involves a risk of spillage and, while driving, is potentially dangerous. A foam that could be sprayed directly into the mouth would be safer and more convenient.

We have now discovered that a non-dairy, cappuccino-style coffee can be prepared by spraying a foamed aqueous solution of a food grade surfactant, which has an HLB greater than 9, onto a cup of coffee. We have also discovered that such foams can be used to provide a wide range of other toppings, drinks or confections.

We have further discovered that aqueous alcoholic beverages may be foamed using a food grade surfactant as aforesaid to provide an attractive topping for drinks and foods and that energy drinks may be similarly foamed and sprayed directly into the mouth.

In particular we have found that sugar esters having an HLB greater than 9 provide particularly acceptable foams for food and beverage use, especially when used in conjunction with aqueous alcohol, methylcellulose and/or glycerol.

We have additionally discovered that the solubility of sugar esters in aqueous alcohol is improved by the presence of sugar.

We have discovered that mixtures of surfactants having an HLB in the range 9-12, with surfactants having an HLB greater than 12 provide particularly stable foams.

We have also discovered that mixtures of methylcellulose with saponins, and in particular with triterpenoid glycosides such as quillaja saponins, are particularly suitable in foam systems containing less than about 10% ethanol.

We have further discovered that non-ionic surfactants such as sugar esters are soluble in concentrated ethanol, e.g. 95% to 97% ethanol such as the neutral spirit, which is commonly used as the basis for drinks such as gin and vodka. These are commonly made by diluting a concentrate, consisting of neutral spirit and any flavourings or other adjuvants, to a final ethanol concentration, which is usually in the range 30 to 40%. We have found that e.g. sugar esters are sufficiently soluble in neutral spirit to provide foamable products on dilution.

Alcoholic foams in accordance with the invention are also useful as a vehicle for applying fragrances to the skin without the spillage which is usually associated with the use of perfumes, colognes and aftershave.

The invention provides the following embodiments:
1. A foam for use as, or as topping for, or component of a food or drink, comprising an aqueous or aqueous ethanolic solution of a surfactant, which is suitable for food use, and which has an HLB greater than 9;
2. A method of forming a foam topping on a drink or food, which comprises spraying thereon a foam as aforesaid;
3. Means for making a foam, which comprises an aqueous or aqueous ethanolic solution of a surfactant as aforesaid, and means adapted to dispense the solution as a foam;
4. The use of an aqueous or aqueous ethanolic food grade surfactant as aforesaid to make a foamed or foam-topped drink or food;
5. An aqueous or aqueous alcoholic solution of food grade surfactants, for use as aforesaid, comprising at least one surfactant having an HLB between 9 and 12 and at least one surfactant having an HLB greater than 12.
6. An aqueous or aqueous alcoholic solution as aforesaid, wherein the surfactants consist essentially of non-ionic surfactants and/or saponins.
7. An aqueous or aqueous alcoholic solution of surfactants as aforesaid, wherein the surfactants are substantially non-ethoxylated.
8. An aqueous or aqueous alcoholic solution of surfactants as aforesaid consisting essentially of surfactants selected from sugar esters, modified celluloses and saponins.
9. An aqueous or aqueous alcoholic solution of a surfactant suitable for food use, having a mean HLB greater than 9, and comprising a mixture of methylcellulose and a sugar ester;
10. An aqueous or aqueous alcoholic solution of a surfactant suitable for food use, having a mean HLB greater than 9, and comprising a mixture of methylcellulose and a saponin;
11. An aqueous alcoholic solution for use in the preparation of foams as aforesaid, which comprises from 10 to 40% by weight ethanol and sufficient of a sugar ester having an HLB greater than 9 to be effective as a foaming agent;
12. An aqueous alcoholic solution according to paragraph 11 above, which additionally comprises from 7 to 40% by weight of sugar;
13. An aqueous or aqueous alcoholic solution according to any of paragraphs 5 to 12 above, which additionally comprises glycerol;
14. A concentrate adapted for use in the manufacture of solutions according to paragraph 11 comprising neutral spirit and the requisite concentration of sugar ester.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Compositions above 5 Ps do not pass readily through foam heads. The viscosity of a sprayable formulation is preferably less than 4 Ps, more preferably less than 3 Ps, still more preferably less than 2 Ps most preferably less than 1.5 Ps. All references to viscosity herein, unless stated to the contrary, are to the viscosity as measured on a Brookfield viscometer at 21 s⁻¹.

In order to obtain satisfactory foam in the absence of auxiliary stabilisers, we prefer to use non-ionic surfactants or saponins with an HLB greater than 10. More preferably the surfactants have a mean HLB greater than 11, even more preferably greater than 12, still more preferably greater than 13, most preferably greater than 14.5. While higher HLBs could be even more suitable, from the point of view of foaming, in practice we have been unable to identify any commercially available products, which are suitable for food use and which have an HLB substantially higher than 15. Most higher-HLB surfactants are not permitted for food use or have undesirable flavours, which are hard to mask. We prefer that the surfactant has an HLB less than 40, more preferably less than 30, still more preferably less than 20, most preferably less than 16.

Generally, we have found that surfactants having an HLB in the lower part of the range, e.g. 9 to 12, tend to give foams that collapse on standing, decreasing in volume, but retaining their density, while surfactants with HLB above 12 tend to give foams that maintain their volume for extended periods, but undergo drainage, resulting in loss of foam density. Surprisingly, however, mixtures of the higher and lower HLB surfactants combine the resistance to collapse of the former with the resistance to drainage of the latter.

Preferably the surfactant comprises at least 50%, more preferably at least 60%, even more preferably at least 70%, most preferably at least 80% by weight of the lower HLB surfactant and at least 0.5%, more preferably at least 1%, even more preferably at least 2%, most preferably at least 5% by weight of the higher HLB surfactant, all based on the total weight of surfactant.

For example the surfactant may typically comprise fatty acid ethoxylates, ethoxylated glyceryl esters, alkyl or alkenyl sugar esters, e.g. sucrose esters, ethoxylated sorbitan esters, saponins, hydroxylated phospholipids and/or cellulose derivatives. Specific examples include sucrose palmitate or stearate, sucrose oleate, methylcellulose, ethoxylated sorbitan oleate, ethoxylated starch and ethoxylated castor oil.

Of these we have found that ethoxylated sorbitan esters give especially good foam quality, but have a slight bitter taste and are therefore generally only suitable in products having a strong masking flavouring. The surfactants in our solution are therefore preferably substantially free from alkoxy groups. That is to say they contain an average of less than 1 alkoxy group, preferably less than 0.5, more preferably less than 0.1, most preferably less than 0.01 alkoxy groups per molecule of surfactant.

Methylcellulose is preferable on flavour grounds but gives a less satisfactory foam quality, when used alone. Typically methyl cellulose has an HLB around 11, and therefore requires a small amount of a higher HLB surfactant to make a fully stable foam.

Sugar esters are particularly preferred on grounds of taste and foam quality, especially in conjunction with alcohol or with lower HLB surfactants, such as methyl cellulose or lecithin. Aqueous sugar esters in the absence of ethanol or a cosurfactant tend to give solutions that are too viscous to pass through a conventional foam head. Suitable esters include octanoates, decanoates, laurates, myristates, palmitates, stearates, behenates, oleates, linoleates, linolenates, erucates and mixtures thereof. Lower molecular weight alkyl esters, such as sucrose laurate, have a slightly soapy taste, but higher mole weight esters, such as stearate and oleate are essentially tasteless. Mixtures comprising the higher homologues with a minor amount of the lower homologues are often preferred for better solubility combined with negligible adverse taste. Sugar esters tend to provide good foams at particularly low concentrations.

The sugar is preferably a mono or, more preferably, disaccharide sugar, most preferably sucrose, but could for example be fructose, maltose, glucose or invert sugar. Other sugars, which could be used, but are unlikely to be commercially attractive, include, for example, mannose, ribose, galactose, lactose, allose, altrose, talose, gulose, idose, arabinose, xylose, lyxose, erythrose, threose, acrose, rhamnose, fucose, glyceraldehyde, stachyose, agavose and cellobiose or a tri- or tetra-saccharide.

Most commercially available sugar esters comprise a mixture of mono- and di-esters. In the case of saturated esters these are not always fully soluble in aqueous or aqueous alcoholic systems at all water/alcohol ratios. Moreover, on standing at low temperatures, sediment sometimes forms, which may block the foam head.

The problem may be avoided by using products comprising essentially the mono ester, or by storing the solution at low temperature, e.g. 5° C. for a short period, e.g. three to five days, and separating any sediment by filtration, centrifugation and/or decantation. We have found that, counter-intuitively, turbidity in very dilute sugar ester solutions can often be avoided by increasing the concentration of the ester. We have also found that the addition of a small amount of sugar, e.g. at least about 7% by weight has a similar effect in clearing turbidity of dilute sugar ester solutions.

We particularly prefer to use sucrose oleate, which has been found to dissolve fully in aqueous alcoholic systems at most water/ethanol ratios, to form stable solutions. Commercial sucrose oleate typically comprises mono-oleate with smaller amounts of di-oleate and saturated esters.

Sugar esters alone tend to be too viscous, if the alcohol concentration is less than about 10% by weight. Mixtures of methylcellulose and sugar ester are particularly effective at providing durable foams without any off-tastes, in non-alcoholic or low alcoholic solutions. Methyl cellulose is less effective in alcoholic systems.

Especially in alcohol-free systems, we prefer a mixture of methylcellulose with sugar esters, wherein the latter comprise a major part of oleate and a minor proportion of a lower mole weight saturated ester, such as laurate. For example the total proportion of sugar ester may be at least 1, preferably at least 5, more preferably at least 10, most preferably at least 15%, but less than 60, more preferably less than 50, still more preferably less than 30, most preferably less than 20% based on the weight of the total surfactant. The proportion of oleate is preferably at least 50, more preferably at least 60% by weight of the total sugar ester. The proportion of lower alkylate is preferably at least 20%, more preferably at least 30% of the total weight of sugar ester.

One disadvantage of sugar esters is their hydrolytic instability in acid systems. This is not a problem in alcoholic systems, in which the alcohol acts as a preservative, but may constrict the choice of formulation in non-alcoholic systems. In the latter, preservatives may be required, such as sorbate/benzoate, which is most effective at slightly acid pH, e.g. around pH 4. In such systems we prefer to use saponins, and especially triterpenoid glycosides such as quillaja saponins, which are acid stable and provide good foaming, especially when used in conjunction with a lower HLB surfactant, such as methyl cellulose. We prefer to use a mixture of lower HLB surfactant with at least 0.5% by weight of saponin, based on the total weight of surfactant, more preferably at least 1%, even more preferably at least 1.5%, most preferably at least 2%. We generally prefer that the weight of saponin is less than 20%, more preferably less than 10%, even more preferably less than 5%, most preferably less than 2% based on the total weight of surfactant.

The total concentration of surfactant is preferably greater than 0.03%, more preferably greater than 0.04%, still more preferably greater than 0.1%, most preferably greater than 0.3%, but less than 10%, more preferably less than 5%, still more preferably less than 3%, most preferably less than 1% by weight based on the total weight of the solution. The optimum concentration varies according to the surfactant and can readily be determined for particular cases.

Sugar esters give good foam stability at 0.04%, but not at 0.02%. Most other surfactants need significantly higher concentrations for good foam stability. We prefer to use the minimum consistent with acceptable foam stability. Generally the use of surfactant levels above the minimum carries little, if any, added benefit.

In addition to water and surfactant, the solution may contain ancillary ingredients such as ethanol, flavourings, sweeteners, foam stabilisers, preservatives, buffers, and/or fragrances.

Sugar is effective as a sweetener, and also to inhibit turbidity in alcoholic sugar ester solutions at low concentrations of sugar ester and alcohol. Sugar is also useful as a foam stabiliser. Sugar concentrations above 50% by weight may give rise to solutions that are too viscous to be readily sprayed through a foam head. Generally we prefer sugar concentrations below 40%, more preferably below 30% by weight. The sugar is preferably sucrose, but may be any of those listed above in relation to the sugar component of the sugar ester.

Ethanol may typically be present in concentrations up to 50%, preferably up to 40%, more preferably up to 37%, still more preferably up to 35%, most preferably up to 30% by weight of the composition. Typically a potable spirit, such as gin, vodka, brandy, whisky, schnapps, rum, a liqueur, a fortified wine or any other fermented, fortified and/or distilled drink may be used as the solvent medium.

Generally it is difficult to obtain satisfactory foam at ethanol concentrations above 37.5% by weight. Difficulties may also be encountered at concentrations between about 5% and 10% by weight. Particularly good results are obtained at concentrations of more than 15% by weight ethanol. If it is desired to foam spirits containing more than 40% by weight ethanol, it is generally preferred to dilute to below 35%, in order to obtain good foam.

Apart from ethanol, other food-acceptable and water-miscible mono and/or polyhydric alcohols and/or alcohol ethers, such as isopropanol may be included, if required to improve homogeneity.

Glycerol has been found to enhance the foaming characteristics, e.g. when present in proportions of more than 0.1%, preferably more than 0.5%, more preferably more than 1% and up to 5%, preferably less than 4%, more preferably less than 3%, most preferably less than 2.5% based on the weight of the composition. In aqueous alcoholic systems, the amount of glycerol is typically high relative to the amount of surfactant, e.g. up to 6:1 by weight, preferably up to 5:1. In non-alcoholic systems the preferred amount is lower, e.g. 1:2 to 1:4 based on the weight of surfactant. For surfactant systems having a relatively low mean HLB, e.g. below 12, we prefer to include a foam stabiliser, such as propylene glycol alginate, trisodium citrate or xanthan gum in an effective proportion, e.g. at least 0.001, preferably more than 0.005, most preferably more than 0.01% by weight, based on the weight of the composition, but less than 2%, preferably less than 1%, more preferably less than 0.5%, most preferably less than 0.1%.

The compositions, and particularly the non-alcoholic ones, may require the presence of a preservative, such as sodium benzoate and potassium sorbate. Where a sorbate/benzoate preservative is used we prefer that the pH of the system be adjusted to an acid value, below 7, preferably below 6, more preferably below 5, most preferably below 4.5. Preferably the pH is above 2, more preferably above 3, most preferably above 3.5. The pH of the solution may be adjusted, e.g. with citric acid.

Some surfactants, e.g. sorbitan esters or sucrose laurate have a taste, which may be masked by the presence of strong flavourings, such as, for example, vanilla, lemon orange, lime, chocolate or ginger. Sucrose oleate, saponins and methyl cellulose are, however, tasteless at the optimum concentration.

The solution may be foamed by dispensing through a foam generator comprising a mixing chamber in which the liquid is mixed with air, steam or an inert gas. For example the solution may be packed in a bottle provided with a foam head and means for pumping the liquid and atmospheric air simultaneously through the foam head.

Conveniently the bottle may be a squeeze bottle and the pumping action may be effected by squeezing the bottle. Alternatively the solution may be packed in an aerosol foam dispenser, or in a dispenser of the type in which the foam is delivered through a nozzle, which activates a pump when depressed. Suitable dispensers are widely used in the personal care industry e.g. for body washes, shaving foams and the like. One such dispenser is sold commercially under the registered trade mark “REXAM EZI FOAMER”.

It is also possible to form the foam by agitating the solution in air, e.g. using a mechanical stirrer or whisk. This method is applicable to foaming solutions that are too viscous to pass through a conventional foam head. When liquids are added to foams formed in this way, the foam forms a layer above the liquid.

Products according to the invention may be used as toppings for cappuccino-style coffee, or to provide a foam head on any type of drink, such as, for example, hot chocolate or milk shakes or on deserts, or as a flavoured confection in their own right. Alcoholic foams may be served as such, or used to provide a topping for beer, cocktails, ice cream, syllabubs, sundaes and the like.

The invention covers concentrates, e.g. based on spirits, such as neutral spirit, that contain levels of alcohol above those that can be satisfactorily foamed, e.g. greater than 90% by weight. Concentrates according to the invention contain surfactant in concentrations adapted to provide foamable products of the invention when the concentrate is diluted with water, e.g. to alcohol levels in the range 15 to 35% by weight. The concentrate may additionally contain other ingredients required in the final beverage, such as juniper extract and other flavours for gin.

The invention is illustrated by the following examples in which all proportions are % by weight based on the total weight of the composition unless stated to the contrary. Unless stated to the contrary, references to sucrose oleate refer to total solids derived from “OWA-1570”, which is sold by Ryoto Ester SP, and which consists of 21% sucrose monooleate, 7% sucrose dioleate, 12% other sucrose alkylates, 4% ethanol and 56% water. References to saponin, unless stated to the contrary, are to total saponin solids derived from “QUILLAJA LIQUID ULTRA 661F/PL”, supplied by Guinness Products, and having an HLB>13

### EXAMPLE I

### Cappuccino

The solution set out in Table I was packed in a squeeze bottle provided with a “REXAM EZI FOAMER”® foam spray head. 5 g of the solution was sprayed onto a cup of freshly prepared instant coffee. It formed 50 ml of a pleasant tasting, creamy, cappuccino-like foam head on the coffee. After 20 minutes the surface of the coffee was still completely covered by 25 ml of foam.

TABLE I

| | |
|---|---|
| Sucrose laurate | 0.4 |
| Glycerol | 0.2 |
| Vanilla flavour | 3.0 |
| Propylene glycol alginate | 0.01 |
| Potassium sorbate | 0.2 |
| Sodium benzoate | 0.2 |
| Citric acid | 0.2 |
| Sodium saccharin | 0.01 |
| Water | balance |

Bold aligned disulfide bonds
Italics bridging peptide

### EXAMPLE II

The composition of Table II was sprayed through a “REXAM M3 Minifoamer”® filling a half pint glass (36 g of solution). A good creamy foam was obtained, which was capable of supporting particles of chocolate. No reduction in volume was observed over a period of 30 minutes, but the foam density reduced. There was no detectable bitterness.

TABLE II

| | |
|---|---|
| Methyl cellulose food grade. | 0.5 |
| Sucrose Oleate | 0.06 |
| Sucrose Laurate | 0.03 |
| Potassium Sorbate | 0.08 |
| Sodium Benzoate | 0.08 |
| Flavouring | 0.25 |
| Demineralised Water | 98.97 |

### EXAMPLE III

The composition of Table III was sprayed through a “REXAM M3 Minifoamer”® filling a half pint glass (36 g of solution). A good creamy foam was obtained, which was capable of supporting particles of chocolate. No reduction in volume was observed over a period of 30 minutes, but the foam density reduced. There was no detectable bitterness.

TABLE III

| | |
|---|---|
| Methyl cellulose (food grade) | 0.5 |
| Saponin | 0.01 |
| Liquid chocolate flavour | 0.3 |
| Potassium sorbate | 0.8 |
| Sodium benzoate | 0.8 |
| Citric acid | 0.8 |
| Sodium saccharine | 0.035 |
| Water | balance |

### EXAMPLE IV

### Foaming Cherry Vodka

100 g vodka (37.5% by volume alcohol); 2 g sucrose palmitate/stearate (HLB 16.0, 75% monoester); 1 g natural red food colouring (propylene glycol+carmine); and 2 g cherry flavouring were stirred vigorously at room temperature for 15 minutes and centrifuged at 6000 G for 15 minutes to spin out residual solids (solids will block foamer nozzle).

The composition was a clear red, with a viscosity of 10 cps measured at 21 s⁻¹ and 20° C.

On standing in a cold incubator for five days a precipitate formed, which is believed to consist mainly of sucrose diester. Filtration removed the diester, leaving a stable product, which was decanted into a “REXAM” M3 mini foamer.

When dispensed through the M3 into a half pint glass a dense soft pale pink foam was obtained which slowly collapsed over ca. 20 minutes to leave 25 ml of cherry flavoured vodka. The sucrose ester did not impart any bitterness.

### EXAMPLE V

### Foaming Scotch Whisky

100 g Scotch whisky (40% by volume alcohol) and 0.8 g sucrose oleate were stirred together for three minutes. The oleate dissolved fully in the whisky to form a clear, stable solution. On dispensing through a “REXAM” M3 mini foamer, a quantity equivalent to a single measure provided half a pint of dense whisky flavoured foam.

### EXAMPLE VI

The appearance of aqueous ethanol solutions containing 0.4% sucrose oleate with 2.0% glycerol and their behaviour after spraying through a foam head, were determined for a range of ethanol concentrations, as set out in table IV:

TABLE IV

| | Foam duration | |
|---|---|---|
| % Ethanol | (minutes) | Appearance |
| 5 | — | Turbid, viscous solution |
| 10 | >15 | Hazy, thin solution |
| 15 | >15 | Clear, thin solution |
| 20 | >15 | Clear, thin solution |
| 35 | >15 | Clear, thin solution |
| 37.5 | 10 | Slightly hazy thin solution |
| 40 | 3 | Hazy, thin solution |
| 45 | <1 | Turbid, thin solution |
| 50 | <1 | Turbid, thin solution |
| 55 | <1 | Hazy, thin solution |
| 60 | <<1 | Clear, thin solution |

On the basis of the above results the whisky used in Example V was diluted with water to 33% by weight alcohol. Then 0.4% sucrose oleate and 2.0% glycerol were added. A substantially superior foam was obtained that persisted for over 45 minutes.

### EXAMPLE VII

Sucrose oleate was dissolved at various concentrations between 0.02 and 0.4% in 20%, 25%, 30% and 35% ethanol solutions. Samples were stored at 3° C. and at room temperature. Certain of the solutions were turbid, due to the presence of small crystalline particles which separate out on standing. The results were recorded in the following Table V, in which “S” indicates a clear solution, “H” a slightly hazy solution and “T” a turbid solution.

TABLE V

| | % EtOH | | | | | | | |
|---|---|---|---|---|---|---|---|---|
| % sucrose | 20 | 20 | 25 | 25 | 30 | 30 | 35 | 35 |
| ester | 3° C. | R/T | 3° C. | R/T | 3° C. | R/T | 3° C. | R/T |
| 0.4 | T | S | T | S | S | S | S | S |
| 0.2 | T | S | T | S | S | S | S | S |
| 0.1 | T | S | T | S | H | S | H | T |
| 0.04 | T | S | T | S | T | H | T | T |
| 0.02 | T | S | T | S | T | T | T | T |

Addition of sucrose in quantities between 7 and 40% rendered the turbid solutions clear. At 25% ethanol, raising the ester concentration to 0.8% or 1.6% also gave clear solutions.

### EXAMPLE VIII

The whisky product of example VI was foamed by whisking with a milk foamer. On addition of hot coffee a stable head of foam formed above the liquid.

1. A foam for use as, or as a topping for or component of a food or drink, comprising an aqueous or aqueous ethanolic solution of at least one surfactant, which is suitable for food use, and which has an HLB above 9.

2. A method of forming a foam topping on a drink or food, which comprises spraying thereon a foam according to claim 1.

3. Means for making a foam, according to claim 1 which comprises an aqueous or aqueous ethanolic solution of a food grade surfactant, which has an HLB greater than 9, and means adapted to dispense the solution as a foam.

4. The use of an aqueous or aqueous ethanolic food grade surfactant, which has an HLB greater than 9, to make a foamed or foam-topped drink or food.

5. An aqueous or aqueous alcoholic solution for use according to claim 4, comprising at least one surfactant having an HLB between 9 and 12 and at least one surfactant having an HLB greater than 12.

6. An aqueous or aqueous alcoholic solution according to claim 5, wherein the surfactants consist essentially of non-ionic surfactants and/or saponins.

7. An aqueous or aqueous alcoholic solution according to claim 6 wherein the surfactants are substantially non-ethoxylated.

8. An aqueous or aqueous alcoholic solution according to claim 7 wherein the surfactants consist essentially of sugar esters, modified celluloses and/or saponins.

9. An aqueous or aqueous alcoholic solution of non-ionic surfactant suitable for food use, having a mean HLB greater than 9, for use according to claim 4 and comprising a mixture of methylcellulose and a sugar ester.

10. An aqueous or aqueous alcoholic solution of surfactant suitable for food use, having a mean HLB greater than 9, for use according to claim 4 and comprising a mixture of methylcellulose and a saponin.

11. An aqueous alcoholic solution for use in the preparation of foams according to claim 1, which comprises from 10 to 40% by weight ethanol and sufficient of a sugar ester having an HLB greater than 9 to be effective as a foaming agent.

12. An aqueous alcoholic solution according to claim 11, which additionally comprises from 7 to 40% by weight of sugar.

13. An aqueous or aqueous alcoholic solution according to, claim 5, which additionally comprises glycerol.

14. A concentrate for use in the manufacture of solutions according to claim 11 comprising neutral spirit and the requisite concentration of sugar ester.
